(19) United States
(12) Patent Application Publication
(10) Pub. No.: US 2002/0120550 A1
(43) Pub. Date: Aug. 29, 2002

(54) Computer online trading method for integrating sale and purchase processes and a system for the same

(76) Inventor: Chen-Shi Yang, Shi-Chih City (TW)

Correspondence Address: DOUGHERTY & TROXELL, Suite 1404, 5205 Leesburg Pike, Falls Church, VA, 22041, US

(21) Appl. No.: 09/791,719

(22) Filed: Feb. 26, 2001

(51) Int. Cl. G06F 17/60

(52) U.S. Cl. 705/37

(57) ABSTRACT

A computer online trading method for integrating sale and purchase processes and a system for the same comprises setting up a business web site in a server of an enterprise, wherein the web site can permit a trader, through internet, to perform a purchase process with a supplier and a sale process with a client. The business web site includes therein an enterprise trade system that comprises: a supplier trade management, a client trade management system, a payment and logistics management system, and a report analysis management system. The present invention principally provides a sale and purchase integrated processes computer online trading system that can have a simplified purchase process, and opened inquiry and negotiation related information, such that the labor cost can be reduced.

### BACKGROUND OF THE INVENTION

The present invention relates to a method of computer online trading for integrating business sale and purchase and the system for the same. More particularly, the present invention relates to a method for integrating the business sale and purchase through setting up a web site, and a system for the same.

### DESCRIPTION OF THE RELATED ART

Conventionally, the enterprise purchase model is that in which the purchase is performed by purchase employees. Only after the enterprise employees pointed out the demands, then the purchase employees can inquire, compare, and negotiate the prices of products to be purchased vis-à-vis the suppliers. The order of the products is performed only after the negotiation of purchase prices was achieved. Such a purchase process is time consuming, and has other drawbacks such as a complete confidence in the purchase employees of the enterprise, the type of the suppliers, the amount and documents not easy to obtain, and non-opened negotiation process. In this case, if an experienced purchase employee happens to quit the company, a newly employed purchase employee cannot learn immediately the know-how acquired by the former purchase employee, and needs to learn from scratch.

Besides, an e-shopping trading model may be so far widespread, but it only shows show the products of the enterprise on a business web site. Consequently, its advantage is limited to a reduction of the shop-window and a replacement of the shop cost. The whole trade management of the enterprise thus still relies on conventional processes of sales, products management, manufactures, purchases and accountant departments. Moreover, although many enterprises may currently use sale-storing software applications, but most of those software applications only provide data records and paperwork management functions, while information analysis and decision propositions are critically missing. As a result, conventional human resource for purchase, sales, management, and accounting cannot be entirely replaced. Moreover, the integration of the information related to the client and the information related to the supplier cannot be performed. This lack of information integration causes the enterprise not to be able to make the correct decisions at critical moment, which affects the adaptation ability of the enterprise.

### SUMMARY OF THE INVENTION

A major aspect of the present invention is to provide a computer online trading method for integrating the purchase and sale processes, and a system for the same, wherein there are provided a simplified purchase process and opened price inquiry information, such that the human resource management cost is reduced.

Another aspect of the present invention is to provide a computer online trading method for integrating the purchase and sale processes and a system for the same, wherein the sale process management efficiency can be improved, while the employ of internet permits an opening to the international market, which benefits to the product sales and the enterprise innovation.

Yet, another aspect of the present invention is to provide a computer online trading method for integrating the purchase and sale processes and a system for the same, wherein the resources related to respectively the enterprise, the upstream supplier, and the downstream client are integrated through the employ of a web site to obtain an replenishment/sale/stock management.

Further, another aspect of the present invention is to provide a computer online trading method for the integrating purchase and sale processes and a system for the same, wherein an analysis of the information related to the upstream supplier and the downstream client can be quickly carried out to provide strategy proposition.

To attain the above and other objects, the computer online trading method for integrating the purchase and sale processes and the system for the same, according to the present invention, integrates the purchase and sale related information of the enterprise, and permits to carry out a computer online trading, such that the loading for conventional enterprise purchase and sale employees can be replaced to achieve a simplified management.

### BRIEF DESCRIPTION OF THE DRAWINGS

The objects, features and advantages of the present invention will be better understood through the following detailed description with the help of the accompanying drawings, wherein:

FIG. 1 is a diagram illustrating the structure of the internet business according to an embodiment of the present invention;

FIG. 2 is a block diagram illustrating the structure of the purchase and sale integrated processes computer online trading system according to an embodiment of the present invention;

FIG. 3A is a flow chart illustrating the process of purchase inquiry according to an embodiment of the present invention;

FIG. 3B is a flow chart illustrating the process of purchase negotiation according to an embodiment of the present invention;

FIG. 3C is a flow chart illustrating the process that is performed by the purchase management system according to an embodiment of the present invention;

FIG. 4A is a flow chart illustrating the process of sales quotation according to an embodiment of the present invention;

FIG. 4B is a flow chart illustrating the process of sales negotiation management according to an embodiment of the present invention;

FIG. 4C is a flow chart illustrating the process that is performed by the sales order management system according to an embodiment of the present invention;

FIG. 5A, FIG. 5B, and FIG. 5C are flow charts illustrating the process of account payable, account receivable, and delivery management according to an embodiment of the present invention; and

FIG. 6 is a flow chart showing the process of analysis management according to an embodiment of the present invention.

### DETAILED DESCRIPTION OF THE PREFERRED EMBODIMENTS

The following description of the present invention is intended to be illustrative only and not limiting, and like reference numerals are used for like and corresponding parts of various drawings.

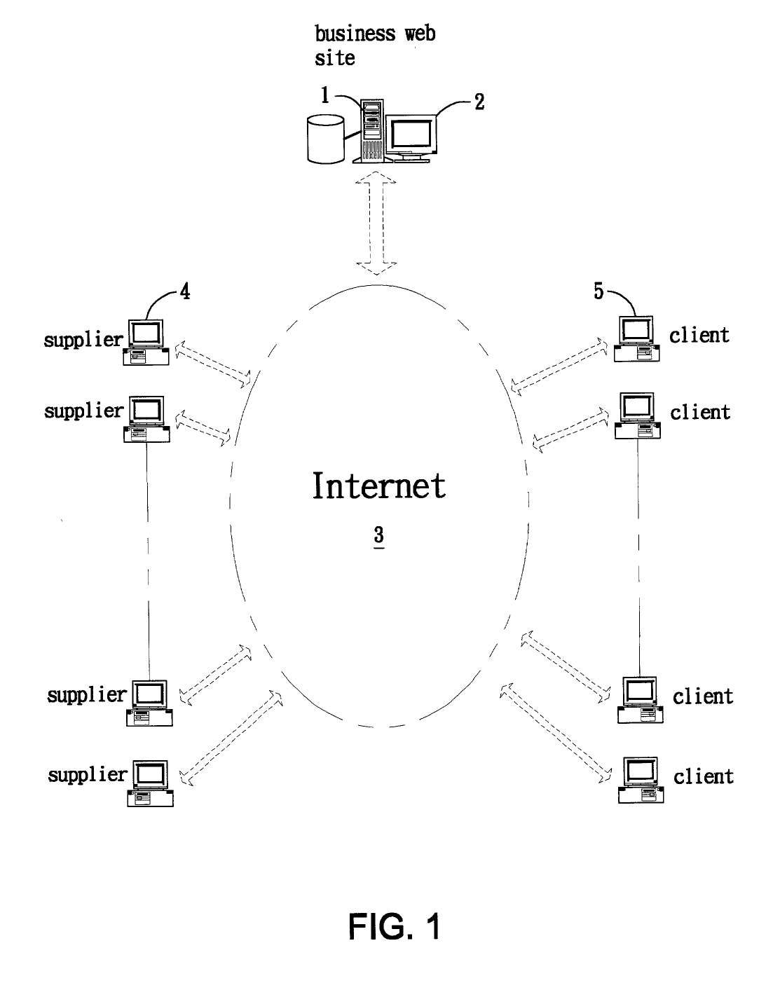

Referring now to FIG. 1, there is shown a trading structure for performing the purchase and sale processes through internet 3, according to a preferred embodiment of the present invention. A business web site 2 is set up in a server 1 of the enterprise. The business web site 2 allows a trader of the enterprise, through internet 3, to carry out purchase processes with a plurality of suppliers 4 and sale processes with a plurality of clients 5. A trader of the enterprise can be a purchase employee as well as a sales employee of the enterprise. Each of the suppliers 4 and each of the clients 5 also can connect to internet 3 and register into the business web site 2 to trade with the enterprise. The web page format of the business web site 2 is written in conventional languages as HTML, JAVA SCRIPT, SQL and JSP, and includes the use of conventional cast structure, object oriented technology and interactive interface. The hardware that is employed to connect to internet comprises a computer, a modem, a xDSL modem, a cable modem, high debit lines, etc, while the software applications that are used comprises a web page browser and an email sender/receiver.

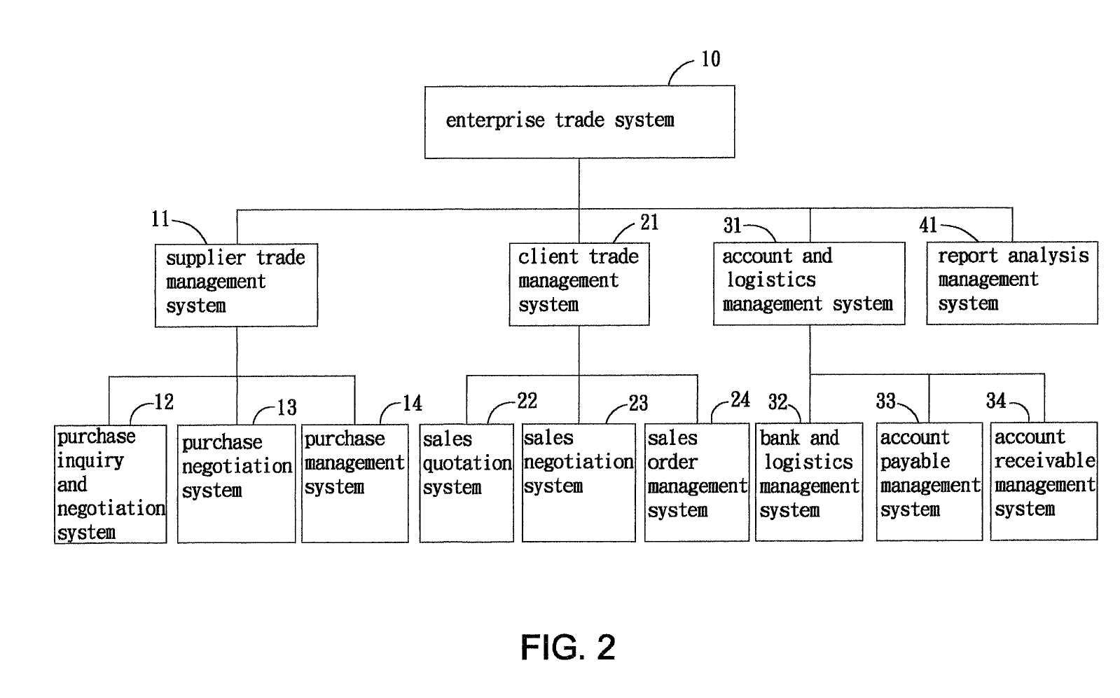

Referring to FIG. 2, a block diagram shows the structure of a computer online trading system integrating the enterprise purchase and sale processes, according to an embodiment of the invention. As described above, the business web site 2 is set up in the server 1 of the enterprise. The business web site 2, besides having conventional enterprise information and product information, principally has an enterprise trading system 10. The enterprise trading system 10 allows enterprise employees to connect to internet 3 and carry out a multiple of processes including purchase, sale, and payment processes, as well as report analysis. The enterprise trade system 10 also allows a plurality of suppliers 4 to go online and register their basic information and the products that are sold, while a plurality of clients 5 can go online and, in turn, purchases the products sold by the enterprise. In accordance with the embodiment of the present invention, after either an enterprise employee, any supplier 4 or client 5 registered into the business web site 2 for the first time, the related information are automatically saved in the server 1. Therefore, the next time the supplier or client is connected, there is no need to input the information again, and business processes can be immediately executed.

The enterprise trading system 10 of the present invention comprises a supplier trade management system 11, a client trade management system 21, an account and logistics management system 31 and a report analysis management 41. The supplier trade management system 11 is principally directed to execute the enterprise purchase process and comprises a purchase inquiry and negotiation system 12, a purchase negotiation system 13, and a purchase management system 14. Inasmuch as the purchase process is with the supplier 4, the present invention thus can automatically search for the products available from the suppliers 4, and automatically with each of the plurality of suppliers 4 carry out an inquiry and negotiation of the prices, as well as an order process. Thus, it is not necessary for the enterprise to repeat the same process with each of the suppliers 4. As a result, the present invention allows substantially reducing the purchase time and labor cost.

In the enterprise trade system 10, the client trade management system 21 is principally directed to execute the enterprise sale process and comprises a sales quotation system 22, a sales negotiation management system 23, and a sales order management system 24. Inasmuch as the sale process can be carried out with other enterprises as well as individual persons, thus the present invention also can manage quotation, negotiation and order process according to the amount of the purchase.

The account and logistics management system 31 is directed to specifically process the management of the enterprise merchandise delivery and the management of the bank current account. The account and logistics management system 31 can also process other processes among which an account payable management vis-à-vis the supplier 4, and an account receivable management. The account and logistics management system 31 comprises a bank and logistics management system 32, an account payable management system 33, and an account receivable management system 34.

The report analysis management system 41 of the invention is directed to integrate and analyze a report of the enterprise product purchases and a report of the enterprise product sales. Also, in addition to performing a product statistical analysis, the report analysis management system 41 performs a plurality of tasks comprising analysis of payment, analysis of time efficiency, etc. Thereby, the trader is aided to make the most appropriate decision within a minimum period of time for adjusting the business running model.

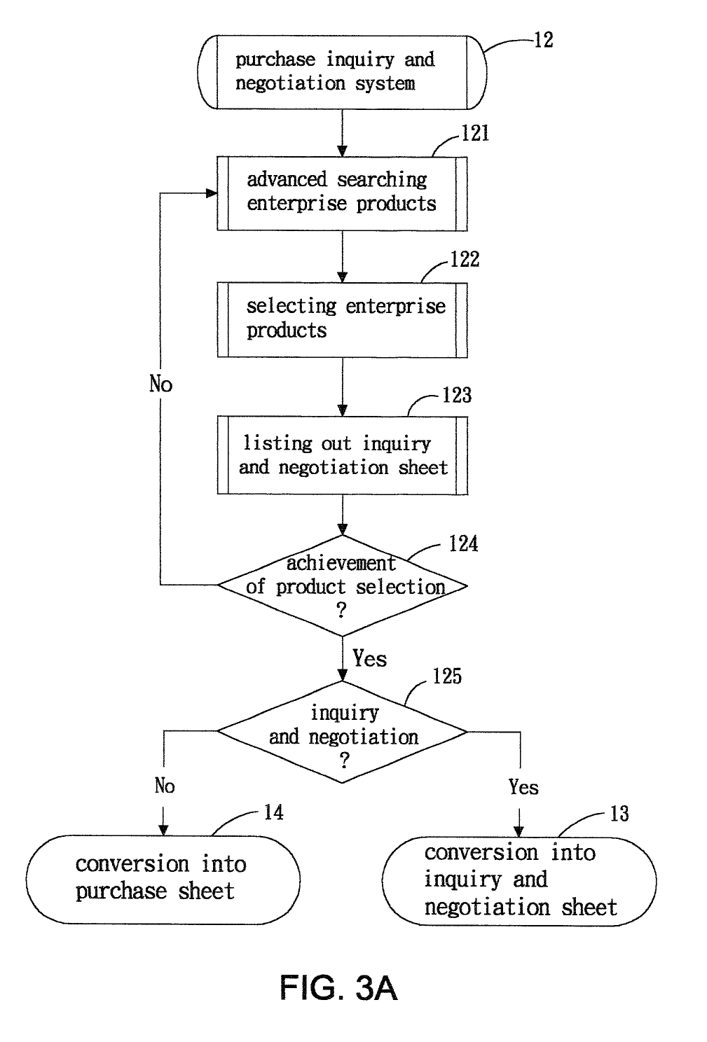

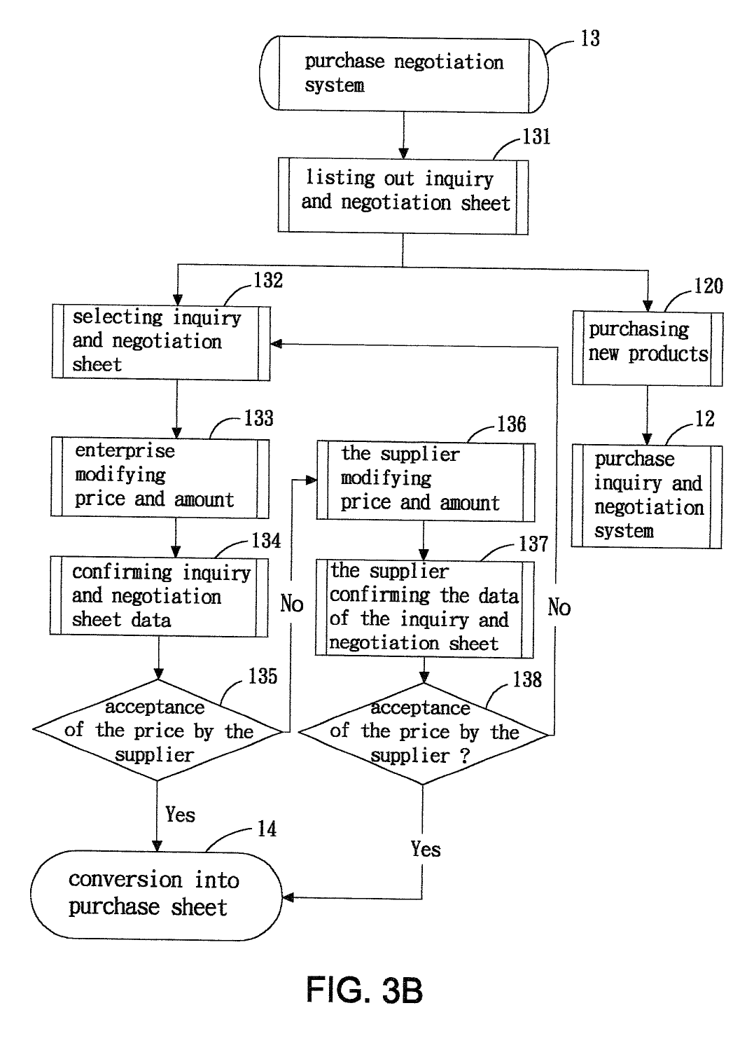

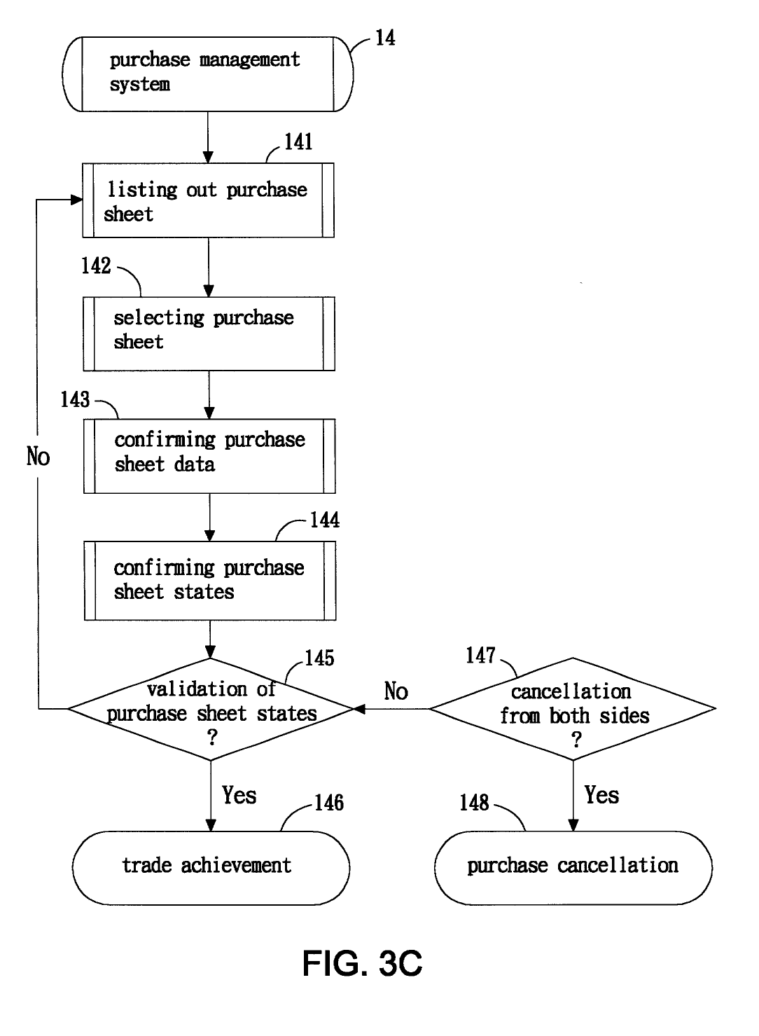

Referring to FIG. 3A, a flow chart illustrates the processes of product purchase and price inquiry, according to the embodiment of the invention. To carry out the product purchase, the trader uses a computer to register into the business web site 2, enters the supplier trade management system 11, and executes the purchase inquiry and negotiation system 12. The process executed by the purchase inquiry and negotiation system 12 comprises:

(a) searching for the products to be purchased, wherein all the information related to the products and the corresponding suppliers have been priory saved in the server 1; the purchase employee only needs to enter the enterprise product advanced search and enter either a product name or product code, or directly select the product icon displayed on the computer monitor, the present invention then can automatically display the model, the price and the suppliers of the product;

(b) from the information related to the product that are displayed, selecting the product item wanted according to the model, price or suppliers (step 122);

(c) storing the selected product item into an inquiry and negotiation sheet that is saved in the server 1 (step 123);

(d) repeating step (a) to step (c) if the product selection is not finished; if it is finished, then step (e) is executed (step 124);

(e) opting whether the inquiry and negotiation sheets should be transferred to the supplier for negotiating the prices (step 125); if one wants to negotiate the price, then entering the purchase negotiation system 13 to perform the negotiation process; if one does not want to negotiate the price, then directly converting the inquiry and negotiation sheet into a purchase order sheet, saving the purchase order sheet into the server 1, and executing the purchase order sheet management system 14.

Referring now to FIG. 3B, a flow chart illustrates the process of purchase negotiation according to the embodiment of the present invention. The process performed by the purchase negotiation management system 13 comprise:

(a) listing out the inquiry and negotiation sheets saved in the server 1 (step 131);

(b) allowing the purchase employee to choose the inquiry and negotiation sheet for inquiry and negotiation (step 132);

(c) the purchase employee modifies the amount of products and the price (step 133), if the data of the inquiry and negotiation sheet are not changed during the first inquiry and negotiation, then going to step (d);

(d) after confirming that there are no errors in the data of the inquiry and negotiation sheet, outputting for negotiation the inquiry and negotiation sheet while saving it in the server 1; the present invention can automatically inform one or more suppliers of the product in the inquiry and negotiation sheet, and request each of the suppliers 4 to quote and negotiate the price;

(e) after the supplier has received the inquiry and negotiation notice, the supplier registers into the business web site to watch the concerned inquiry and negotiation sheet, decides whether the inquiry and negotiation sheet can be accepted (step 135); if it is accepted, then the inquiry and negotiation sheet is converted into a purchase order sheet that is saved in the server 1, the supplier then executes the purchase management system 14; if it is not accepted, then step (f) is executed;

(f) the supplier 4 modifies the amount and price of the products in the inquiry and negotiation sheet (step 136);

(g) after confirming there are no errors in the data of the inquiry and negotiation sheet, transmitting the inquiry and negotiation sheet to the enterprise purchase employee (step 137), and saving the inquiry and negotiation sheet in the server 1;

(h) after the purchase employee has received one or more inquiry and negotiation sheets from the suppliers, the purchase employee can perform the negotiation process again (step 138), then returning to step (c); if the purchase employee accepts one inquiry and negotiation sheet of the supplier, the inquiry and negotiation sheet is then converted into a purchase order sheet that is saved in the server 1, the purchase employee then executes the purchase management system 14;

(i) during the inquiry and negotiation process, the purchase employee may also at any time perform a new product purchase process (step 120), then executing the purchase inquiry and negotiation system 12.

Referring now to FIG. 3C, a flow chart illustrates the purchase management system according to an embodiment of the present invention. The process executed by the purchase management system 14 comprises:

(a) listing out the purchase order sheets saved in the server 1 (step 141);

(b) the purchase employee chooses a purchase order sheet (step 142);

(c) confirming that the data of the purchase order sheet is correct (step 143), if it is correct, then transmitting the purchase order sheet to the supplier;

(d) confirming states of the purchase order sheet, the states of the purchase order sheet comprising: whether the supplier has received the purchase order sheet, whether the product was delivered or whether the payment was settled up. (step 144);

(e) if the supplier 4 has not received the purchase order sheet, then re-execute step (a) to step (c) (step 145); if the products have not been delivered yet, informing the supplier to deliver the merchandise or informing the logistics system to receive the merchandise; if the payment has not been settled up, then informing the accountant or the bank to settle up the payment;

(f) if all the processes of step (e) were completely achieved such that all the purchase order sheet states are validated, the present purchase process is finished (step 146);

(g) at step (d) while confirming the states of the purchase order sheet, the present invention can automatically determine whether there is an order cancellation during the trade process between both sides 147, if there was a cancellation, then execute step (h);

(h) canceling the purchase process (step 148).

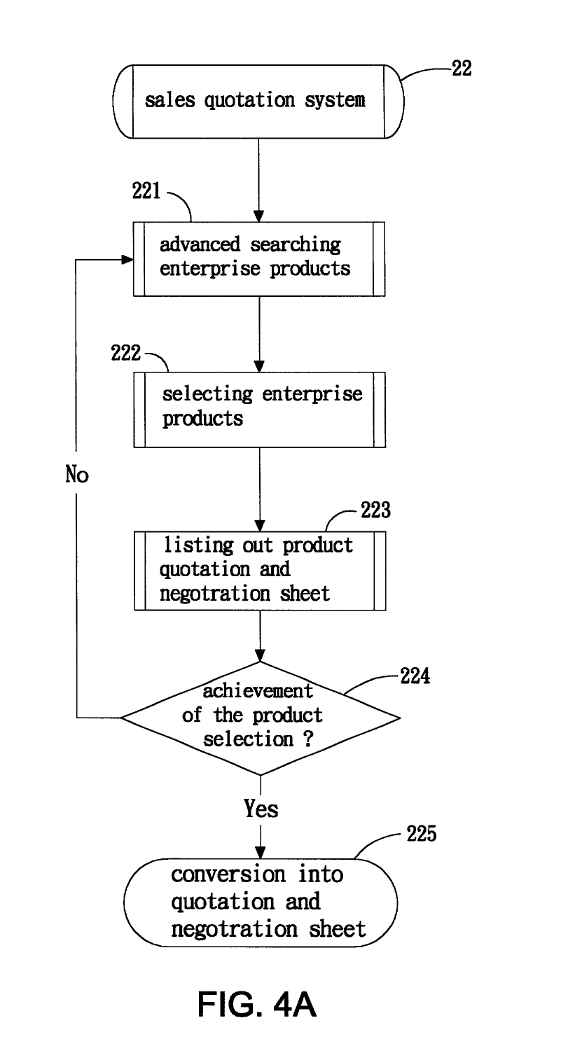

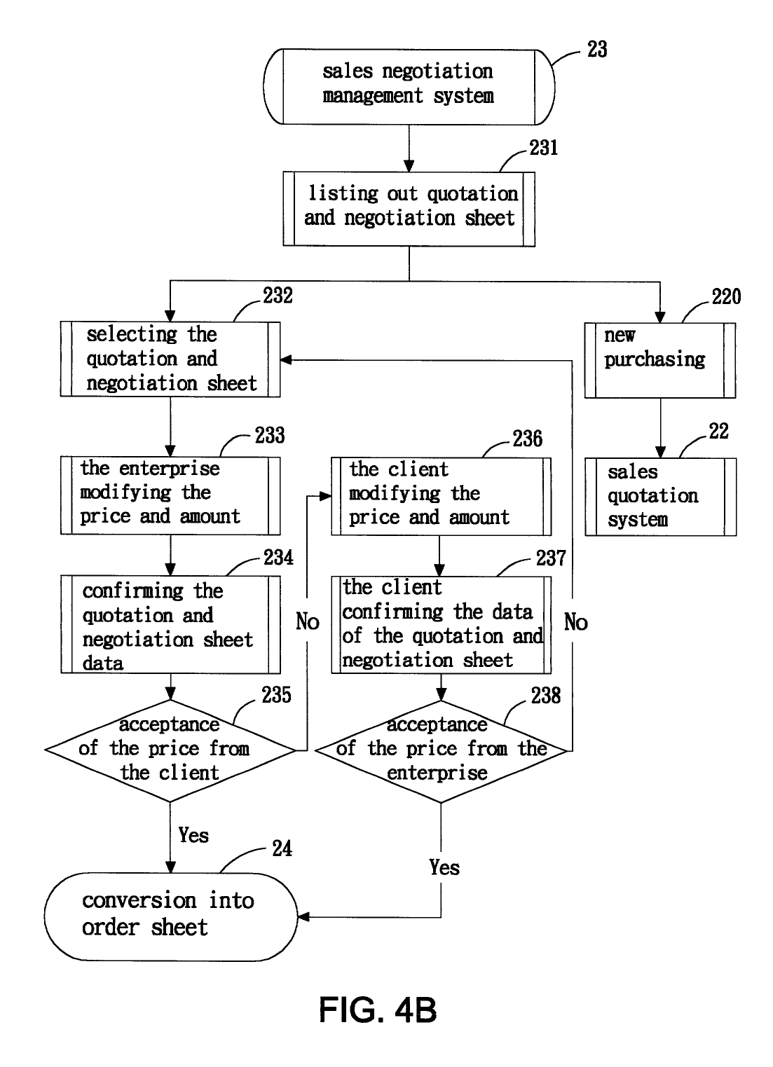

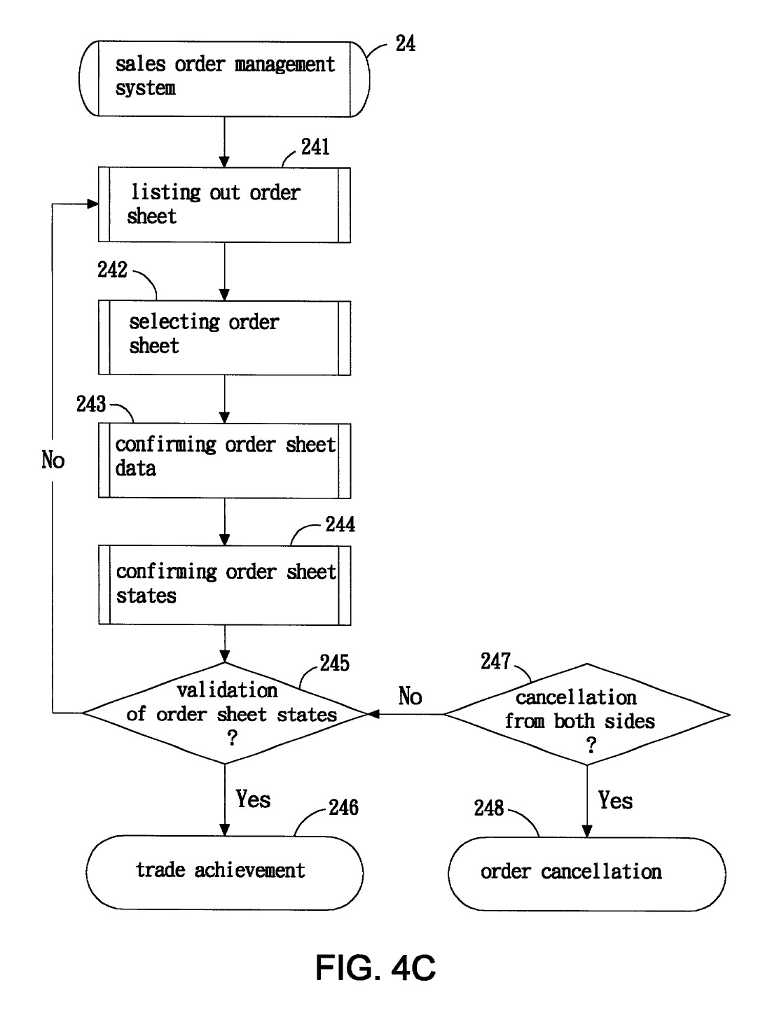

Referring now to FIG. 4A, a flow chart illustrates the process of sales quotation, according to an embodiment of the present invention. Similarly to the above description, when a client wants to purchase products of the enterprise, the client uses a computer to register into the business web site 2 and enters the client trade management system 21 to execute the sales quotation system 22. The process performed by the sales quotation system 22 comprises:

(a) searching for the products to be purchased, wherein all the information related to the products sold by the enterprise have been priory saved in the server 1; the client only needs to enter the enterprise product advanced search (step 221) and inputs either a product name or a product code, or directly select the product icon list out on the computer monitor, the present invention then can automatically display the model and price of the product;

(b) from the information related to the product that are displayed, selecting the wanted product item according to the model (step 222);

(c) storing the selected product item into a product quotation and negotiation sheet that is saved in the server 1 (step 223);

(d) repeating step (a) to step (c) if the product selection process is not finished, if it is finished, then step (e) is executed (step 224);

(e) after the product selection process has been achieved, then executing the sales negotiation management system (step 225).

Referring now to FIG. 4B, a flow chart illustrates the process of the sales negotiation management, according to an embodiment of the present invention. When the present invention receives a quotation and negotiation sheet from the client, the enterprise sale employee is immediately informed, and is requested to register into the business web site 2 to perform the product sales negotiation. The process executed by the sales negotiation management system 23 comprises:

(a) listing out the quotation and negotiation sheets saved in the server 1 (step 231);

(b) the sale employee chooses a sales quotation and negotiation sheet to be negotiated (step 232);

(c) the sale employee modifies the amount and price of the product of the quotation and negotiation sheet (step 233);

(d) after confirming that there are no errors in the data of the quotation and negotiation sheet, transmitting the quotation and negotiation sheet to the client (step 234) while saving it in the server 1;

(e) after the client has received the quotation and negotiation notice, the client watches the quotation and negotiation sheet and decides whether it can be accepted (step 235); if it is accepted, the quotation and negotiation sheet is converted into an order sheet that is saved in the server 1, the sales order management system 24 is then executed; if the quotation and negotiation sheet is not accepted, then step (f) is executed;

(f) the client modifies the amount and price of the quotation and negotiation sheet (step 236);

(g) after confirming there are no errors in the data that were input, transmitting the quotation and negotiation sheet to the enterprise sale employee (step 237), and saving the quotation and negotiation sheet in the server 1;

(h) after receiving the quotation and negotiation sheet from the client, the sale employee decides whether the quotation and negotiation sheet should be accepted (step 238); if it is not accepted, then returning to step (c); if it is accepted, the quotation and negotiation sheet is converted into an order sheet that is saved in the server 1, the sales order management system 24 is then executed.

(i) during the quotation and negotiation process, the client at any time can perform a new product item purchase (step 220); in that case, the sales quotation and negotiation system 22 then is executed.

Referring now to FIG. 4C, a flow chart illustrates the sale confirmation process, according to an embodiment of the present invention. The process executed by the sales order management system 24 comprises:

(a) listing out the order sheets saved in the server 1 (step 241);

(b) the sale employee selects an order sheet to be processed (step 242);

(c) confirming that the data of the sales order sheet is correct (step 243);

(d) confirming states of the sales order sheet, wherein the states of the sales order sheet comprise: whether the sale employee has already processed the sales order sheet, whether the products have been delivered or the whether the payment was received; (step 244);

(e) if the sale employee has not processed yet the sales order sheet, then returning to step (a) to step (c) (step 245); if the products have not been delivered yet, then informing the supplier to deliver the merchandise or informing the logistics system to deliver the merchandise; if the payment was not settled up, then informing the accountant or the bank to cash in;

(f) if all the processes of step (e) were completely achieved such that all the states of the order sheet are validated, the present sale process is finished (step 246);

(g) at step (d) while confirming the state of the sales order sheet, the present invention can automatically determine whether there was a cancellation of the order process from both trading sides (step 247), if it is the case, then step (h) is executed;

(h) canceling the sale process (step 248).

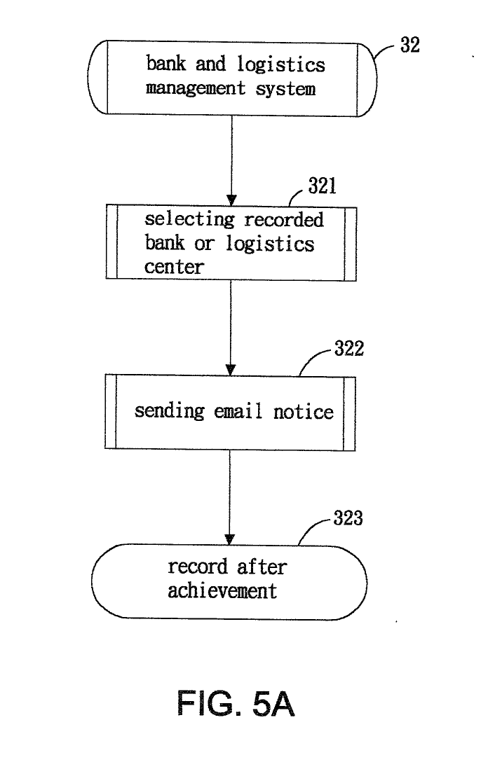

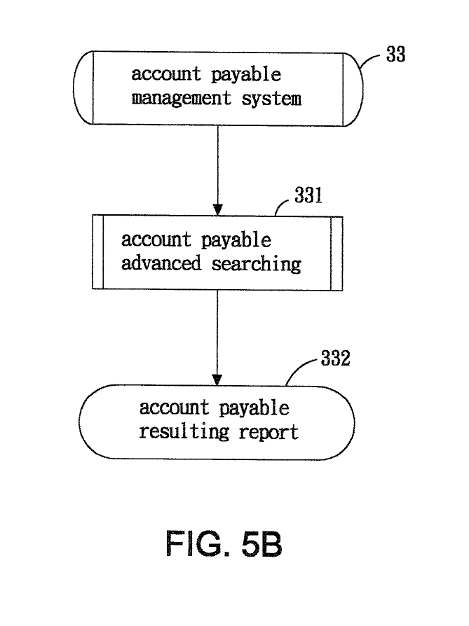

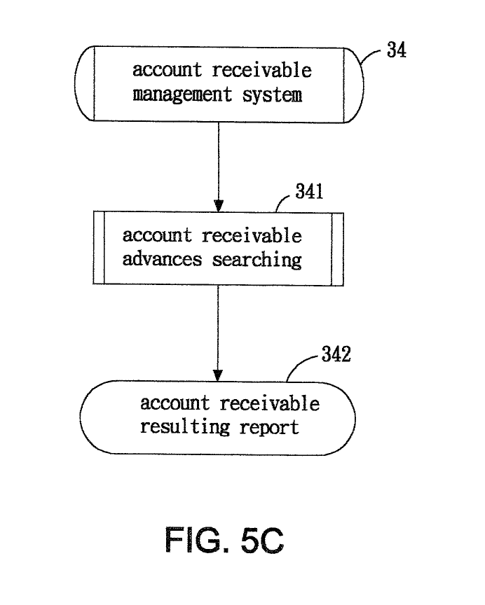

Referring now to FIG. 5A, FIG. 5B, and FIG. 5C, there are shown flow charts illustrating the account payable, account receivable, and delivery processes according to an embodiment of the present invention. After achieving either the purchase or sale processes, the present invention can immediately inform an accountant or a stock manager or other concerned employees of the enterprise to perform the trade post-processes. As shown in FIG. 5A, when a trade process is achieved, the present invention can automatically inform the accountant and the stock manager to register into the business web site 2, enter the accounts and logistics management system 31, and execute the bank and logistics management system 32. The process executed by the bank and logistics management system 32 comprises: (a) selecting a bank or logistics center recorded in the server 1 (step 321); (b) informing the bank or the logistics center of the achieved trade documents by email (step 322), requesting the bank to pay or requesting the logistics center to deliver the merchandise; and (c) after paying or delivering the merchandise, immediately informing the accountant and the stock manager to record the related documents (step 323).

As shown in FIG. 5B, the present invention, according to the need, generates a daily account payable report, a weekly report, a monthly report, a seasonally report or an annually report. To generate the account payable report, the accountant registers into the business web site 2, enters into the payment and logistics management system 31, and executes the account payable management system 33. The process performed by the account payable management system 33 comprises: (a) searching for daily purchase records, weekly purchase records, monthly purchase records, seasonally purchase records, or annually purchase records, wherein the accountant, according to the need, enters the account payable advanced search 331 to conduct the search of the purchase records; and (b) generating the report 332 from the account payable result of the record. As shown in FIG. 5C, the present invention can also generate daily account receivable reports, weekly account receivable reports, monthly account receivable report, seasonably account receivable reports, or annually account receivable reports. To generate the account receivable report, the accountant registers into the business web site 2, enters the payment and logistics management system 31, and executes the account receivable management system 34. The process performed by the account receivable management system 34 comprises: (a) searching for daily sale records, weekly sale records, monthly sale records, seasonally sale records, or annually sale records, wherein the accountant, according to the demand, enters into the account receivable advanced searching (step 341) to conduct the search of the sale records; and (b) generating the report (step 342) from the account receivable result of the record.

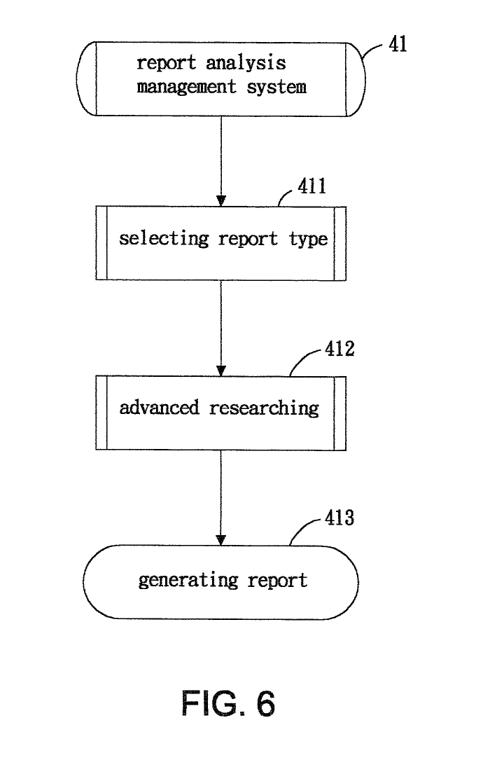

Referring to FIG. 6, there is shown a flow chart illustrating an analysis process that is carried out by analyzing a purchase report and a sale report, according to an embodiment of the present invention. The present invention can automatically perform an analysis from the purchase and sale documents. Hence, it is possible to know for instance which types of products are well sold, which types of products have larger gross profit, and the whole enterprise profit. The present invention can allow a manager of the enterprise to register into the business web site 2, and execute the report analysis management system 41. The process performed by the report analysis management system 41 comprises: (a) choosing the type of report 411, wherein the type of the report comprises for instance the enterprise product balance report, the enterprise asset report, the enterprise working gross profit report, and the enterprise net profit report (the foregoing list of reports is not restricting and other types of reports can be generated); (b) advanced searching trade records, and calculating the result thereof; and (c) generating a report 413 from the record and calculating result.

In conclusion, in accordance with the above description of an embodiment of the present invention, the present invention has at least the following advantages.

The present invention can substantially simplify the purchase process, reduce the cost, reduce the sale and labor management cost, and improve the efficiency of the management.

According to another advantage of the present invention, different functional tasks of the order and manufacture processes can be chosen according to the actual demand of the enterprise, and a replenishment/sale/stock process can be electronically generated.

Yet, according to another advantage of the present invention, the presently clients can be kept with certainty while potential clients can be gained. An effective control of the business achievement and an improvement of the service quality are obtained and the competitiveness of the enterprise hence can be strengthened.

Yet, according to another advantage of the present invention, a real time management and communication with the client can be obtained, consequently the organization of the sale process and its rate of progress can be controlled with certainty.

Yet, according to another advantage of the present invention, business diagrams and reports can be automatically generated, and decisions and analysis can be performed according to the client behavior and consumer model.

As understood by a person skilled in the art, the foregoing description of the preferred embodiment and examples of the present invention are only illustrative rather than limiting. Revisions and modifications may be made to processes, materials, and structures through which is provided the foregoing embodiment of the present invention without departing from the spirit and scope of the present invention as defined by the following appended claims.

What is claimed is:

1. A computer online trading system for integrating sale and purchase processes, wherein the computer online trading system for integrating sale and purchase processes is within a business web site that is set up in a server of an enterprise, such that a trader of the enterprise can, through internet, perform purchases with any suppliers and sales with any clients, wherein the purchase and sale are performed through a plurality of employees of the enterprise that are computer online, a plurality of suppliers that are online to register the product information thereof, and a plurality of clients that are online to purchase products, the computer online trading system for integrating sale and purchase processes comprising:
a supplier trade management system that is directed to perform enterprise purchase processes;
a client trade management system that is directed to perform enterprise product sale processes;
a payment and logistics management system that is directed to process a management of respectively enterprise merchandise deliveries and bank current accounts, wherein the payment and logistics management system is also directed to process respectively an account payable management with at least a supplier and an account receivable management with at least a client; and
a report analysis management system that is directed to perform an analysis from the combination of enterprise product purchase reports and enterprise product sale reports, wherein the analysis comprises product statistics analysis, payment analysis, and date analysis.

2. The computer online trading system for integrating sale and purchase processes of claim 1, wherein the supplier trade management system comprises:
a purchase inquiry system;
a purchase negotiation system; and
a purchase management system;
wherein the supplier trade management system automatically searches for the products sold by the suppliers and automatically performs inquiry and negotiation processes and order process vis-à-vis each of the plurality of suppliers.

3. The computer online trading system for integrating sale and purchase processes of claim 1, wherein the client trade management system comprises:
a sales quotation system;
a sales negotiation management system; and
a sales order management system;
wherein the client trade management system performs quotations, negotiations, and order processes.

4. The computer online trading system for integrating sale and purchase processes of claim 1, wherein the payment and logistics management system comprises:
a bank and logistics management system;
an account payable management system; and
an account receivable management system.

5. The computer online trading system for integrating sale and purchase processes of claim 1, wherein the computer online trading system for integrating sale and purchase processes can automatically save the information related to respectively the enterprise employee, the supplier, or the client when they are online and register for the first time, such that when they are online again, the registration information are not needed to be entered again.

6. A purchase inquiry and negotiation process executed by the purchase inquiry and negotiation system inside the supplier trade management system of claim 2, wherein the purchase inquiry and negotiation process comprises:
(a) entering into an enterprise advanced search to search for a product to be purchased, wherein the model, price and suppliers of the product are automatically listed out after either an input of a product name or product code, or a direct selection of product icons;
(b) selecting a wanted product item among the product information listed;
(c) saving the selected product item into an inquiry and negotiation sheet that is saved up;
(d) repeating step (a) to step (c) if the selection of products is not finished, otherwise performing step (e); and
(e) deciding whether the inquiry and negotiation sheet should be transmitted to the supplier; if it should be transmitted, then executing the purchase negotiation system; if it should not be transmitted, then converting the inquiry and negotiation sheet into a purchase order sheet and executing the purchase management system.

7. A purchase negotiation process executed by the purchase negotiation system inside the supplier trade management system of claim 2, wherein the purchase negotiation process comprises:
(a) listing out the saved plurality of inquiry and negotiation sheets;
(b) selecting a inquiry and negotiation sheet to be processed;
(c) modifying the product amount and price of the inquiry and negotiation sheet, wherein if, at the first inquiry and negotiation, the data of the inquiry and negotiation sheet were not modified, then going to step (d);
(d) confirming there are no errors in the data of the inquiry and negotiation sheet, then transmitting out the inquiry and negotiation sheet for negotiation;
(e) after the supplier received an inquiry and negotiation notice, deciding whether the inquiry and negotiation sheet can be accepted; if it is accepted, then converting the inquiry and negotiation sheet into a purchase order sheet and then executing the purchase management system; otherwise executing step (f);
(f) modifying the product amount and price of the inquiry and negotiation sheet, wherein the modification is performed by the supplier;
(g) confirming that there are no errors in the data of the inquiry and negotiation sheet, then transmitting the inquiry and negotiation sheet to the enterprise; and
(h) after the enterprise received the inquiry and negotiation sheet from the supplier, if the inquiry and negotiation sheet is not accepted, then performing the inquiry and negotiation again according to the data of the inquiry and negotiation sheet by returning to step (c); if it is accepted, then converting the inquiry and negotiation sheet into a purchase order sheet and executing the purchase management system.

8. The purchase negotiation process of claim 7, wherein a purchase of a new product item can be performed at any time during the inquiry and negotiation through executing the purchase inquiry system.

9. The purchase negotiation process of claim 7, wherein while transmitting the inquiry and negotiation sheet to for inquiry and negotiation, also automatically informing one or more than one suppliers of the product listed in the inquiry and negotiation sheet, and requesting each of the suppliers 4 to quote and negotiate the price.

10. A purchase management process executed by the purchase management system inside the supplier trade management system of claim 2, wherein the purchase management process comprises:
(a) listing out the plurality of purchase order sheets;
(b) selecting a purchase order sheet to be processed;
(c) confirming there are no errors in the data of the purchase order sheet; if it is correct, then transmitting to the supplier;
(d) confirming states of the purchase order sheet, wherein the states of the purchase order sheet comprise: whether the supplier of the product has received the purchase order sheet, whether the product has been delivered, or whether the payment has been settled up;
(e) if the supplier has not received the purchase order sheet, then repeating step (a) to step (c); if the product has not been delivered, then informing the supplier to deliver the merchandise or informing the logistics system to receive the merchandise; if the payment has not been settled up, then informing an accountant of the enterprise or a bank of the enterprise to pay; and
(f) if all the states of step (d) are validated, then closing the purchase process.

11. The purchase management process of claim 10, wherein while confirming the states of the purchase order sheet, determining whether there is a cancellation of the order process from both trading sides, if there is cancellation, then canceling the purchase process.

12. A sales quotation process executed by the sales quotation system inside the client trade management system of claim 3, wherein the sales quotation process comprises:
(a) entering into the enterprise advanced search to search for a product to be purchased, wherein the model, price and suppliers of the product are automatically listed out after either an input by the client of a product name or product code, or a direct selection of product icons by the client;
(b) selecting the wanted product item among the product information listed out;
(c) saving the selected product item into a quotation and negotiation sheet that is saved up;
(d) repeating step (a) to step (c) if the selection of products by the client is not finished, otherwise performing step (e); and
(e) executing the sales negotiation management system.

13. A sales negotiation management process executed by the sales negotiation management system inside the client trade management system of claim 3, wherein the sales negotiation management process comprises:
(a) listing out the saved plurality of quotation and negotiation sheets;
(b) selecting a quotation and negotiation sheet to be negotiated;
(c) modifying the product amount and price of the quotation and negotiation sheet;
(d) confirming there are no errors in the data of the quotation and negotiation sheet, then transmitting out the quotation and negotiation sheet to the client;
(e) after the client received a quotation and negotiation notice, deciding whether the quotation and negotiation sheet can be accepted; if the quotation and negotiation sheet is accepted, then converting the quotation and negotiation sheet into an order sheet and executing the sales order management system; otherwise executing step (f);
(f) modifying the product amount and price of the quotation and negotiation sheet, wherein the modification is performed by the client;
(g) confirming there are no errors in the data of the quotation and negotiation sheet, then transmitting the quotation and negotiation sheet to the enterprise; and
(h) after the enterprise received the quotation and negotiation sheet from the client, if it is not accepted by the enterprise, then performing the quotation and negotiation again by returning to step (c); if the quotation and negotiation sheet is accepted, then converting the quotation and negotiation sheet into an order sheet and then executing the sale management system.

14. The sales negotiation management process of claim 13, wherein during the quotation and negotiation, the client can at any time perform a purchase of a new product item through executing the sales quotation and negotiation system.

15. A sales order management process executed by the sales order management system inside the client trade management system of claim 3, wherein the sales order management process comprises:
(a) listing out the plurality of sales order sheets;
(b) selecting a sales order sheet that is needed to be treated;
(c) confirming there are no errors in the data of the sales order sheet;
(d) confirming states of the sales order sheet, wherein the states of the sales order sheet comprise: whether the sales order sheet was treated, whether the product was delivered, or whether the payment was received;
(e) if the sale employee has not treated the sales order sheet, then repeating step (a) to step (d); if the products have been not delivered, then informing the supplier to deliver the merchandise or informing the logistics system to deliver the merchandise; if the payment was not settled up, then informing the accountant of the enterprise or the bank to receive the payment; and
(f) if all the states of step (d) are validated, then closing the sales process.

16. The sales order management process of claim 15, wherein while confirming the states of the sales order sheet, determining whether there is a cancellation of the sales order process from both trading sides, if yes, then canceling the sales order process.

17. A bank and logistics management process executed by the bank and logistics management system inside the payment and logistics management system of claim 4, wherein when a purchase or sale process is achieved, the accountant and the stock manager are informed to register into the web site, enter the payment and logistics management system, and execute the bank and logistics management system, the bank and logistics management process comprises:
(a) choosing a bank or logistics center that has been recorded;
(b) informing the banks or logistics center about the achieved trade information, and demanding the bank to pay or the logistics center to deliver; and
(c) after paying or delivering, immediately informing an accountant and a stock manager to record the related information.

18. An account payable management process executed by the account payable management system inside the payment and logistics management system of claim 4, wherein the account payable management process comprises:
(a) entering into an account payable advanced search and, according to the need, searching for a purchase record; and
(b) generating a report from the account payable result of the record.

19. An account receivable management process executed by the account receivable management system inside the payment and logistics management system of claim 4, wherein the account receivable management process comprises:
(a) entering into an account receivable advanced search and, according to the need, searching for a sales record; and
(b) generating a report from the account receivable result of the record.

20. A report analysis management process executed by the report analysis management system inside the purchase and sale integrated processes computer online trading system of claim 1, wherein the report analysis management process comprises:
(a) choosing a type of report, wherein the types of report comprise: an enterprise product balance report, an enterprise asset report, and an enterprise working gross profit report, an enterprise net profit report;
(b) advanced searching the trade records and calculating the result thereof; and
(c) generating a report from the record and the calculation result.
